(19) United States
(12) Patent Application Publication
(10) Pub. No.: US 2013/0218804 A1
(43) Pub. Date: Aug. 22, 2013

(54) Method and System for Determining Option-Adjusted True Interest Cost of Municipal Debt Instruments

(71) Applicant: Andrew J. KALOTAY, Spencertown, NY (US)

(72) Inventor: Andrew J. KALOTAY, Spencertown, NY (US)

(73) Assignee: ANDREW KALOTAY ASSOCIATES, INC., New York, NY (US)

(21) Appl. No.: 13/398,655

(22) Filed: Feb. 16, 2012

(51) Int. Cl. G06Q 40/06

(52) U.S. Cl. 705/36 R

(57) ABSTRACT

Methods and systems are disclosed for calculating borrowing cost of municipal debt instruments. In an embodiment, a method receives terms, yield curve and interest rate volatility data for a set of bonds and then specifies an evolution of interest rates for each of the bonds. The method receives an option value V for each of the bonds and determines proceeds P for each bond. The method obtains an Option-Adjusted True Interest Cost (OATIC) for the bonds by adding the option values V to the proceeds P and finding a single discount rate that equates a present value of respective debt service for the bonds to P+V. In another embodiment, a system specifies an evolution of interest rates and receives an option value V for municipal debt offerings. The system selects a bond based on expected costs of bonds, which are calculated using OATIC values and identifies a preferred bond.

### BACKGROUND OF THE DISCLOSURE

1. Field of the Disclosure

The field of the disclosure relates generally to determining interest costs for bonds and more particularly, to determining option-adjusted true interest costs of municipal debt instruments, such as bonds.

2. Description of the Related Art

Municipal debt securities are usually issued (sold) as a series of individual bonds, with different maturity dates and coupons. Sometimes a series may contain two bonds maturing at the same time but having different coupon. The general municipal debt issue can be thought of as a portfolio of individual bonds with a common indenture.

There is a need to encapsulate (quantify) the cost of borrowing in a simple, but at the same time financially meaningful, measure. For example, in a competitive offering, the municipality has to identify the ‘most attractive’, i.e. ‘lowest cost’ issue among the alternatives.

A current industry practice is to represent the cost of borrowing with the so-called True Interest Cost (TIC). TIC is defined as the single discount rate that equates the portfolio-based debt service of the proposed issue to the proceeds P received by the municipality. The unit of TIC is annual interest rate (compounded semiannually). As an example, in the case of an issue consisting of a single bond, the TIC is the yield to maturity (YTM) of the bond that explains the net proceeds (that equates the discounted cash flows to the net proceeds). A desirable property of TIC is that it declines as the proceeds increase, keeping all other variables unchanged.

Although TIC is the most commonly used indicator of cost in the municipal finance industry, occasionally borrowers use a similar measure, Net Interest Cost (NIC). NIC is obtained by simply averaging the interest payments, rather than by an internal rate of return calculation, and it also suffers from a deficiency of TIC, in that NIC does not take options into account. In this way, both TIC an NIC unfairly penalize (from the perspective of the issuer) bonds that have significant optionality in comparison with bonds that do not.

Accordingly, there is a need for a more accurate indicator than conventional TIC and NIC for determining which choice of municipal debt instrument is the most attractive to the issuer from among municipal debt instruments that are callable and/or have optionality, such as, but not limited to, term bonds. What is also needed are systems and methods that enable an issuer to make an informed decision on what bond structure from among those proposed by underwriters (banks) is the best deal.

### SUMMARY OF THE DISCLOSURE

The present disclosure is directed to exemplary methods, exemplary apparatus and exemplary systems that determine option-adjusted true interest cost (OATIC) for municipal debt instruments such as, but not limited to, municipal bonds.

Embodiments disclosed herein encapsulate (quantify) the cost of borrowing in a simple, but at the same time financially meaningful, measure. For example, in a competitive offering (the primary application of the process described in this submission), the municipality has to identify the ‘most attractive’, i.e. ‘lowest cost’ and most preferred issue among a set of alternatives.

Although TIC provides a sensible and satisfactory cost measure provided that the bonds in the issue are optionless, if some of the bonds have embedded (call and/or sinking fund) options, TIC is misleading, because the underlying calculation does not take the value of the option(s) into account. As a practical matter, virtually every long-term municipal bond is callable by the issuer at par any time after Year 10 (occasionally even earlier). Moreover, municipal issues often include so-called term bonds, whose principal is retired (‘sunk’) gradually over time. Term bonds also provide optionality to the issuer: if they trade at a price below par, the issuer may be able to acquire the required amount by open market purchase, rather than pay par for them.

Prospective investors recognize that options described above impede the performance of their bonds, and they seek compensation in the form of a higher coupon or a lower price than those of like optionless bonds. However, because TIC does not take options into account, it unfairly penalizes (from the perspective of the borrower) bonds that have significant optionality in comparison with those that do not.

In order to overcome the deficiencies of conventional TIC and in accordance with techniques disclosed herein, the value V of relevant options is formally included in the calculation of the borrowing cost. In an embodiment, the resulting option-adjusted TIC (OATIC) is obtained by adding the option value V to the proceeds P and then finding the single discount rate that equates the present value of the debt service to P+V. According to an embodiment, in the presence of options, the option-adjusted TIC will be lower than the conventional TIC. Alternatively, in cases where the issue has no optionality, the option-adjusted TIC is the same as it would be under the conventional calculation of TIC.

In accordance with an embodiment, the option value V can be calculated using an industry-standard method, using parameters as specified by the municipality issuing the bond. On a high level, option valuation uses a yield curve and an interest rate volatility term structure. For example, the yield curve could be the previous day's industry-standard Municipal Market Data (MMD) or Municipal Market Advisors (MMA) curve, or the contemporaneous Securities Industry and Financial Markets Association (SIFMA) Municipal Swap Index (‘SFIMA swap curve’). Embodiments can use the industry-standard Black-Derman-Toy or Black-Karasinski processes to specify the evolution of interest rates; there are, of course, other possibilities. While the precise choice of the interest rate process and the associated volatilities affects the absolute level of the option-adjusted TIC values of the funding alternatives, it has an insignificant effect on their relative order.

Further features and advantages of the present disclosure, as well as the structure and operation of various embodiments thereof, are described in detail below with reference to the accompanying drawings. It is noted that the present disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWING FIGURES

The accompanying drawings, which are incorporated herein and form part of the specification, illustrate exemplary embodiments of the present disclosure and, together with the description, further serve to explain principles, aspects and features of the present disclosure. The exemplary embodiments are best understood from the following detailed description when read in conjunction with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 illustrates an exemplary computing system for carrying out the disclosed exemplary municipal bond valuation method in the present disclosure;

FIGS. 2-4 are flow charts illustrating the method steps for determining, from among different bond series, which is the most preferred, in accordance with embodiments of the present invention; and

FIG. 5 is a diagram of an exemplary computer system in which embodiments of the present disclosure can be implemented.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

The present disclosure relates to systems and methods for determining, from among different bond series, which is the most preferred to an issuer. Embodiments of the systems and methods disclosed herein determine option-adjusted TIC for municipal debt instruments, such as, but not limited to, bonds.

### System Embodiment

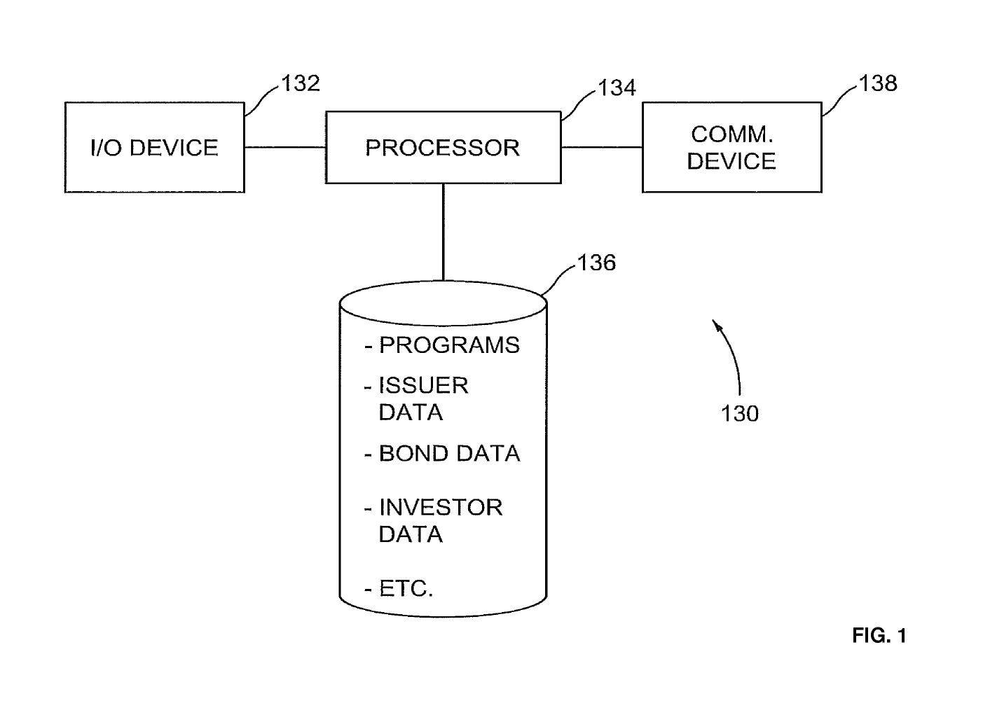

FIG. 1 illustrates an exemplary system 130, for carrying out the disclosed exemplary municipal bond valuation method. As shown in FIG. 1, system 130 can be implemented as a computing device that includes an input/output device 132 for receiving data and instructions from, and communicating information and results to, a user, processor 134 (e.g., a CPU), a memory 136 (e.g., random access memory (RAM) and/or read only memory (ROM)), and a communications device 138 (e.g., receiver/transmitter) for communication with other devices via a communications network (not shown). Stored in the memory are the various programs run on the system 130, as well as a data store or database comprising other information relevant to the disclosed system and method, such as, bond issuer data, bond data, indexer data, etc. In an embodiment, the data store depicted as part of memory 136 can be distributed amongst a plurality of computing devices (not shown) that make up system 130.

### Bonds

In finance terms, a bond is a debt security in which the authorized issuer owes the holders (“bondholders”) a debt and, depending on the terms of the bond, is obliged to pay interest (referred to as the “coupon”) to use and/or to repay the principal at a later date, termed maturity. A bond is a formal contract to repay borrowed money with interest at fixed intervals (e.g., semi annual, annual, monthly, etc.).

Thus, a bond is like a loan, in that the holder of the bond is the lender (creditor), the issuer of the bond is the borrower (debtor), and the coupon is the interest. Bonds provide the borrower with external funds to finance long-term investments or, in the case of government bonds, to finance current expenditure.

Bonds and stocks are both securities. The major difference between bonds and stocks is that stockholders have an equity stake in the company (i.e., they are owners), whereas bondholders have a creditor stake in the company (i.e., they are lenders). Another difference is that bonds usually have a defined term, or maturity, after which the bond is redeemed. On the other hand, stocks may be outstanding indefinitely. An exception to a defined term being associated with a bond is a consol bond, which has no maturity.

### Features of Bonds

The most important features of a bond are described below:

Nominal, Principal or Face Amount (often called “Par”)—The amount on which the issuer pays interest, and which, most typically, has to be repaid at the end of the term. Some structured bonds have what is known as a redemption amount, which is different from the face amount, and which can be linked to the performance of particular assets (e.g., a stock or commodity index, a foreign exchange rate, a fund, etc.). This can result in an investor receiving less or more than his/her original investment at maturity.

Issue Price—The price at which investors buy the bonds when they are first issued. The net proceeds that the issuer of the bond receives are the issue price, minus the issuance fees/expenses. If the bond happens to be sold at an auction, the issue price can vary.

Maturity Date—The date on which the issuer has to repay the nominal amount. As long as all payments have been made during the life of the bond, the issuer has no more obligation to the bond holders after the maturity date. The length of time until the maturity date is often referred to as the term, tenor, or maturity of a bond. The term of a bond can be any length of time. Debt securities with a term of less than one year are, however, generally considered to be money market instruments rather than bonds. The term of most bonds is up to thirty years. Of course, some bonds have been issued with terms of up to one hundred years, and some bonds have been issued that do not mature at all.

In the U.S. Treasury securities market, there are typically three groups of bond maturities:

(1) Short Term (often referred to as “Bills”)—Have maturities of between one to five years (instruments with maturities less than one year are referred to as Money Market Instruments);

(2) Medium Term (often referred to as “Notes”)—Have maturities of between six to twelve years; and

(3) Long Term (often referred to as “Bonds”)—Have maturities greater than twelve years.

Coupon—The interest rate that the issuer pays to the bond holders. Typically, this rate is fixed throughout the life of the bond. However, for floating rate bonds, it can also vary with a money market index (e.g., the London Inter Bank Offered Rate (LIBOR)), or it can be even more exotic. The name “coupon” originates from the fact that in the past, physical bonds were issued which had actual coupons attached to them. On the coupon date(s), the bond holder would give the coupon to a bank in exchange for the payment of the principal and interest (e.g., the face amount).

Coupon Dates—The dates on which the issuer pays the coupon to the bondholders. For a semi-annual bond the issuer pays a coupon every six months.

Quality—The quality of the bond issue refers to the probability that the bondholders will receive the amounts promised at the due dates. The quality of a bond will depend on a wide range of factors, some of which include:

Indentures and Covenants—An indenture is a formal debt agreement that establishes the terms of a bond issue. Covenants are the clauses of such an agreement. Covenants specify the rights of bondholders and the duties of issuers, such as, for example, actions that the issuer is either obligated to perform or is prohibited from performing. In the U.S., federal and state securities and commercial laws apply to the enforcement of these agreements, which are construed by courts as contracts between issuers and bondholders. The terms of such agreements may be changed only with great difficulty while the bonds are outstanding. Any amendments to the governing document generally require approval by a majority, or a super-majority, vote of the bondholders.

High-Yield Bonds—Bonds that are rated below investment grade by the credit rating agencies. As high-yield bonds are more risky than investment grade bonds, investors expect to earn a higher yield. High-yield bonds are sometimes referred to as junk bonds

Optionality—Occasionally a bond may contain option-like features, or embedded options. These are an inherent part of the bond and not a separately traded product. Bond options are not mutually exclusive, and a bond may have several options embedded. Because TIC does not take optionality into account, it unfairly penalizes (from the perspective of the issuer) bonds that have significant optionality in comparison with like bonds that do not. To remedy this, embodiments disclosed herein include the value V of relevant options in the calculation of the borrowing cost. In accordance with an embodiment, the resulting option-adjusted TIC is obtained by adding the option value V to the proceeds P and then finding the single discount rate that equates the present value of the debt service to P+V. Thus, for bonds with embedded options, the option-adjusted TIC will be lower than the conventional TIC.

Callability—An example of an embedded option is a call option. Callable bonds allow the issuer to buy back the bond at a predetermined price at a certain time in the future, before the maturity date. The holder of the bond has, in effect, sold a call option to the issuer. Most callable bonds allow the issuer to repay the bond at par, while for some bonds, the issuer has to pay a premium (the so-called “call premium”). For example, as discussed below with reference to Table 1, 30-year municipal bonds are typically callable at par 10 years after issuance. Bonds that are callable can suffer from impeded performance, and as a result, prospective investors may seek compensation in the form of a higher coupon or a lower price for callable bonds. As is the case with optionality, the option-adjusted TIC calculation takes callability into account. Typically, callable bonds cannot be called for the first few years. This period is known as the “lock out period”.

Sinking Fund—A sinking fund provision of the bond issue requires a certain portion of the bond issue to be retired periodically. The entire bond issue can be liquidated by the maturity date. If that is not the case, then the remainder is called “balloon maturity”. Issuers may either pay to trustees, which in turn call randomly selected bonds in the issue, or, alternately, purchase bonds in the open market and return them to the trustees.

### Types of Bonds

Although, there are many different types of bonds (fixed rate, floating rate, inflation-indexed, etc.), the following descriptions of are of types of bonds which are particularly relevant to embodiments of present disclosure. The following descriptions of various types of bonds are not mutually exclusive, and more than one of them may apply to a particular bond.

Municipal Bond—A bond issued by a township, borough, city, state, U.S. Territory, local government, or their agencies. Interest income received by holders of municipal bonds is typically exempt from federal income tax, and often also from the income tax of the state in which they are issued. Although municipal bonds issued for certain purposes (e.g., private purposes) may not be tax exempt.

Build America Bond (BAB)—A form of municipal bond authorized by the America Recovery and Reinvestment Act of 2009. Unlike traditional municipal bonds, which are usually tax exempt, interest received on a BAB is subject to federal taxation. However, as with municipal bonds, the bond is tax-exempt within the state it is issued. Generally, BABs offer significantly higher yields (often over 7%) than standard municipal bonds.

Lottery Bond—A bond issued by a state, and typically a European state. Interest is paid like a traditional fixed rate bond, but the issuer will redeem randomly selected individual bonds within the issue according to a schedule. Some of these redemptions will be for a higher value than the face value of the bond.

War Bond—A bond issued by a country to fund a war.

Serial Bond—A bond that matures in installments over a period of time. In effect, a $100,000, 5-year serial bond would mature in a $20,000 annuity over a 5-year interval.

Revenue Bond—A special type of municipal bond distinguished by its guarantee of repayment solely from revenues generated by a specified revenue-generating entity associated with the purpose of the bonds. Revenue bonds are typically “non-recourse”, meaning that in the event of default, the bondholder has no recourse to other governmental assets or revenues.

Climate Bond—A bond issued by a government or corporate entity in order to raise finance for climate change mitigation or adaptation related projects or programs.

### Municipal Bonds

Municipal bonds are securities that are issued for the purpose of financing the infrastructure needs of the issuing municipality. These needs vary greatly, but can include, for example, schools, roads, streets, highways, bridges, hospitals, public housing, sewer systems, water systems, power systems, power utilities, and various other public projects. Essentially, through the purchase of a municipal bond, the investor is lending money to the issuer (i.e., the municipality) who promises to repay to the investor the principal plus a fixed or variable amount of interest over time. These investors are called bondholders. Repayment periods can be as short as a few months (although this is rare) to 20, 30, or 40 years, or even longer. Municipal bonds are guaranteed by the government agency of issue.

The municipal issuer that issues the municipal bonds, such as, for example, townships, boroughs, states, cities, counties, etc., typically does so to raise funds for public interest projects for which they do not have immediate funds at their disposal. Alternately, the municipality may have the funds, but not desire to use them. Bonds bear an interest either at a fixed or a variable rate, and can be subject to either, or both, minimum and/or maximum legal limits. Most municipal notes and bonds are issued in minimum denominations of $5,000, or multiples of $5,000.

A bond measure is an initiative to sell bonds for the purpose of acquiring funds for various public works projects, such as, for example, research, transportation infrastructure improvements, educational improvements, and others. These bond measures are put up for a vote in general elections, and must generally be approved by a majority of voters. Such measures are often used in the United States when other revenue sources, such as taxes, are limited or non-existent.

A municipal bond is essentially a way of issuing debt. The methods and traces of issuing debt are governed by an extensive system of laws and regulations, which vary by state. If a bond measure is proposed, for example, in a local county election, a Tax Rate Statement may be provided to voters, detailing best estimates of the tax rate required to levy and fund the bond.

Municipal bonds are generally a highly sought after investment because of their tax-exempt status. Income generated from the purchase of a municipal bond may be exempt from federal, state or local income taxes, depending on the intent of the bond and the laws of each state. For instance, bonds issued for projects intended for the common good (i.e., municipal bonds) are generally classified as tax exempt. Bonds that fund projects for the benefit of private parties are not classified as tax exempt (e.g., offering bonds to support a company coming into the area). Typically, an investor will receives a lower interest rate payment on municipal bonds than on other private bonds because of their special tax exempt status (assuming comparable risk). This makes the issuance of municipal bonds an attractive source of financing to many municipal entities, as the borrowing rate available in the open market is frequently lower than what is available through other borrowing channels.

Municipal bonds are one of several ways states, cities and counties can issue debt. Other mechanisms include certificates of participation and lease-buyback agreements. While these methods of borrowing differ in legal structure, they are similar to the municipal bonds described herein.

Municipal bondholders purchase bonds either directly from the issuer at the time of issuance (on the primary market), or from other bond holders at some time after issuance (on the secondary market). In exchange for an upfront investment of capital, the bondholder receives payments over time composed of interest on the invested principal, and a return of the invested principal itself.

Repayment schedules differ with the type of bond issued. Municipal bonds typically pay interest semi-annually. Shorter term bonds generally pay interest only until maturity. Longer term bonds generally are amortized through annual principal payments. Longer and shorter term bonds are often combined together in a single issue that requires the issuer to make approximately level annual payments of interest and principal. Certain bonds, known as zero coupon or capital appreciation bonds, accrue interest until maturity, at which time both interest and principal become due.

Municipal bonds are highly sought after as they typically provide tax exemption from federal taxes and many state and local taxes, depending on the laws of each state. Purchasers of municipal bonds should be aware, however, that not all municipal bonds are tax-exempt. Bonds are typically certified by a law firm as either tax-exempt (federal and/or state income tax) or taxable, before they are offered to the market.

One of the primary reasons municipal bonds are considered separately from other types of bonds is their special ability to provide tax-exempt income. Interest paid by the issuer to bondholders is often exempt from all federal taxes, as well as state or local taxes, depending on the state in which the issuer is located, subject to certain restrictions. However, bonds issued for certain purposes may be subject to the alternative minimum tax.

The type of project or projects that are funded by a bond affects the taxability of income received on the bonds held by the bondholders. Interest earnings on bonds that fund projects that are constructed for the public good are generally exempt from federal income tax. Interest earnings on bonds issued to fund projects partly or wholly benefiting only private parties, sometimes referred to as private activity bonds, may be subject to federal income tax. However, qualified private activity bonds, whether issued by a governmental unit or private entity, are exempt from federal taxes because the bonds are financing services or facilities that, while meeting the private activity tests, are needed by a government.

Municipal securities consist of both short term issues (often called notes, which typically mature in one year or less) and long term issues (commonly known as bonds, which mature after more than one year). Short term notes are typically used by an issuer to raise money for a variety of reasons (e.g., in anticipation of future revenues such as taxes, state or federal aid payments, and future bond issuances; to cover irregular cash flows; meet unanticipated deficits; raise immediate capital for projects until long term financing can be arranged; etc.). Bonds are usually sold to finance capital or public interest projects over the longer term.

The risk, or security, of a municipal bond is a measure of how likely the issuer is to make all payments, on time and in full, as promised in the agreement between the issuer and the bondholder. Different types of bonds are secured by various types of repayment sources, based on the promises made in the bond documents.

The basic types of municipal bonds are as follows:

(1) General Obligation Bonds—Principal and interest are secured by the full faith and credit of the issuer and usually supported by either the issuer's unlimited or limited taxing power. The issuer promises to repay the principal and interest in full faith. In many cases, general obligation bonds are voter approved and are the more secure of the municipal bonds, which typically means they have low interest rates.

(2) Revenue Bonds—Principal and interest are secured by revenues derived from tolls, charges, water utility payments by customers or rents from the facility built with the proceeds of the bond issue. Public projects financed by revenue bonds include, for example, toll roads, bridges, airports, water and sewage treatment facilities, hospitals and subsidized housing. Many of these bonds are issued by special authorities created for that particular purpose.

(3) Assessment Bonds—Repayment depends on the income received from property tax assessments on properties located within the issuer's boundaries.

The probability of repayment, as promised, is often determined by an independent reviewer, commonly known as a rating agency. The three main rating agencies for municipal bonds in the United States are: (1) Standard & Poor's, (2) Moody's, and (3) Fitch, provided in no particular order. These agencies are hired by the issuer to assign a bond rating to the bond issue. The bond rating is valuable information to potential bondholders that helps sell bonds on the primary market. To alleviate some of the risk, bond insurance may be purchased. Bond insurance is a type of insurance wherein an insurance company guarantees the scheduled payments of interest and principal on a bond, or other security, in the event of a payment default by the issuer of the bond or security. The insurance company is paid a premium (either as a lump sum or in installments) by the issuer or owner of the security to be insured. Bond insurance is a form of credit enhancement that generally results in the rating of the insured security being the higher of: (1) the claims-paying rating of the insurer; and (2) the rating the bond would have absent insurance (which is also known as the “underlying” or “shadow” rating).

Municipal bonds have traditionally had very low rates of default as they are backed either by revenue from public utilities (revenue bonds), or the state and local government power to tax (general obligation bonds). Given the strong backing of municipal bonds, it is unlikely that the municipality will go into bankruptcy or otherwise be unable to make the payments.

Key information about new issues of municipal bonds (including, among other things, the security pledged for repayment of the bonds, the terms of payment of interest and principal of the bonds, the tax-exempt status of the bonds, and material financial and operating information about the issuer of the bonds) can typically be found in the issuer's Official Statement. Official Statements generally are available at no charge from the Electronic Municipal Market Access system (“EMMA”). For most municipal bonds issued in recent years, the issuer is also obligated to provide continuing disclosure to the marketplace, including providing annual financial information and notices of the occurrence of certain material events (including notices of defaults, rating downgrades, events of taxability, etc.). Continuing disclosures also are available for free from the EMMA continuing disclosure service.

### Bond Issuance

Bonds are typically issued by public authorities, credit institutions, companies and supranational institutions in the primary markets. The most common process of issuing bonds is through underwriting. In underwriting, one or more securities firms or banks, forming a syndicate, buy an entire issue of bonds from an issuer (e.g., a municipality, credit institution, etc.) and resell them to investors. The securities firm takes the risk of being unable to sell the issued bonds to end investors. Primary issuance is arranged by bookrunners, who arrange the bond issue, have direct contact with the investors, and act as advisors to the bond issuer in terms of timing and price of the bond issue. The bookrunners' willingness to underwrite must be discussed prior to opening books on a bond issue, as there may be limited appetite to do so given a particular bond issue.

Government bonds are usually issued by auctions, called a public sale, where both members of the public and banks may bid for bond. Since the coupon is fixed, but the price is not, the percent return is a function of both the price paid as well as the coupon. However, because the cost of issuance for a publicly auctioned bond can be cost prohibitive for a smaller loan, it is also common for smaller bonds to avoid the underwriting and auction process through the use of a private placement bond. In the case of private placement bonds, the bond is held by the lender and does not enter the large bond market.

There are occasions where the documentation allows the issuer to borrow more at a later date by issuing further bonds on the same terms as before, but at the current market price. This is typically called a “tap issue” or a “bond tap”.

### Method Embodiments

Investors recognize that callability features and options described above impede the performance of bonds, and as a result, they seek compensation in the form of a higher coupon or a lower price for callable bonds or bonds with optionality as compared to like optionless bonds. As discussed above, because TIC does not take options into account, it unfairly penalizes (from the perspective of the issuer) bonds that have significant optionality in comparison with those that do not.

In order to address this issue, the exemplary method embodiments discussed below formally include the value V of relevant options in the calculation of the borrowing cost. According to an embodiment, the resulting option-adjusted TIC is obtained by adding the option value V to the proceeds P and then finding the single discount rate that equates the present value of the debt service to P+V. Thus, for bonds with options, the option-adjusted TIC will be lower than the conventional TIC. Conversely, if the issue has no optionality, the option-adjusted TIC is the same as it would be under the conventional calculation of TIC.

In one embodiment, the option value V can be calculated using an industry-standard method, using parameters as specified by the municipality. For example, the parameters specified by the municipality can be provided by database of memory 136 described above with reference to FIG. 1. One embodiment of option valuation uses a yield curve and an interest rate volatility term structure. For example, the yield curve could be the previous day's industry-standard MMD or MMA curve, or the contemporaneous SIFMA swap curve. Such data can be retrieved from database of memory 136 of system 130. According to embodiments, various processes, including, but not limited to, the industry-standard Black-Derman-Toy or Black-Karasinski processes, can be used to specify the evolution of interest rates. While the precise choice of the interest rate process and the associated volatilities affects the absolute level of the option-adjusted TIC values of the funding alternatives, it has an insignificant effect on their relative order.

In the example embodiment provided in Table 1 below, two fairly-priced 30-year bond structures are compared. Both are callable at par after 10 years. The first bond has a coupon of 4.50% and is sold at par. Assuming issuance costs of 1% of par, the issuer would receive 99% of par as proceeds. The second bond has a coupon of 5% and is sold at 106.479% of par, with proceeds of 105.479% after issuance costs. The results shown in Table 1 below indicate that when the option-adjusted TIC is obtained, the second choice, the bond having a 5.0% coupon, is the most attractive. As will be appreciated by persons skilled in the relevant art, the par amounts issued would be different, and the fees may also differ.

TABLE 1
Comparison of 30 NC-10* New Issues

| | | | | Option- | |
|---|---|---|---|---|---|
| | | True Interest | Option | Adjusted | Option- |
| Coupon | Proceeds | Cost (TIC) | Value | Proceeds | Adjusted |
| (%) | (% par) | (%) | (% par) | (% par) | TIC (%) |
| 4.50 | 99.000 | 4.562 | 4.041 | 103.041 | 4.318 |
| 5.00 | 105.479 | 4.659 | 6.345 | 111.824 | 4.295 |

*30-year bonds callable at par after 10 years.

In the example embodiment provided in Table 2 below, the benchmark yield curve is used where there is a 12% interest rate volatility and the Black-Karasinski process is applied to calculate the value of the embedded call options. As shown in Table 1, the option value of the 4.50% bond is 4.041% of par, while that of the 5.00% bond is 5.345% of par.

TABLE 2
Benchmark Yield Curve

| | Term | | | | | | | | | |
|---|---|---|---|---|---|---|---|---|---|---|
| | 6 mo | 1 yr | 2 yr | 3 yr | 5 yr | 7 yr | 10 yr | 15 yr | 20 yr | 30 yr |
| Yield | 1.00 | 1.55 | 2.10 | 2.42 | 2.83 | 3.10 | 3.35 | 3.67 | 3.93 | 4.27 |
| (%) | | | | | | | | | | |

In accordance with an embodiment, these option values are added to the proceeds in each case to determine the option-adjusted proceeds (as shown in Table 1, 103.041 and 111.824 respectively). Finally, the option-adjusted proceeds can be used to calculate the option-adjusted TIC in the same manner as used in calculating conventional TIC.

As the results in Table 1 above indicate, if relying solely on the TIC, the issuer would arrive at the erroneous conclusion that the 4.50% par bonds are preferable to the 5.00% premium bonds based on their lower TIC (4.562% vs. 4.659%). However, after adjusting for option values using the exemplary method described herein, the issuer should prefer the 5% bonds based on their lower option-adjusted TIC (4.295% for the 5.00% bonds vs. 4.318% for the 4.50% bonds).

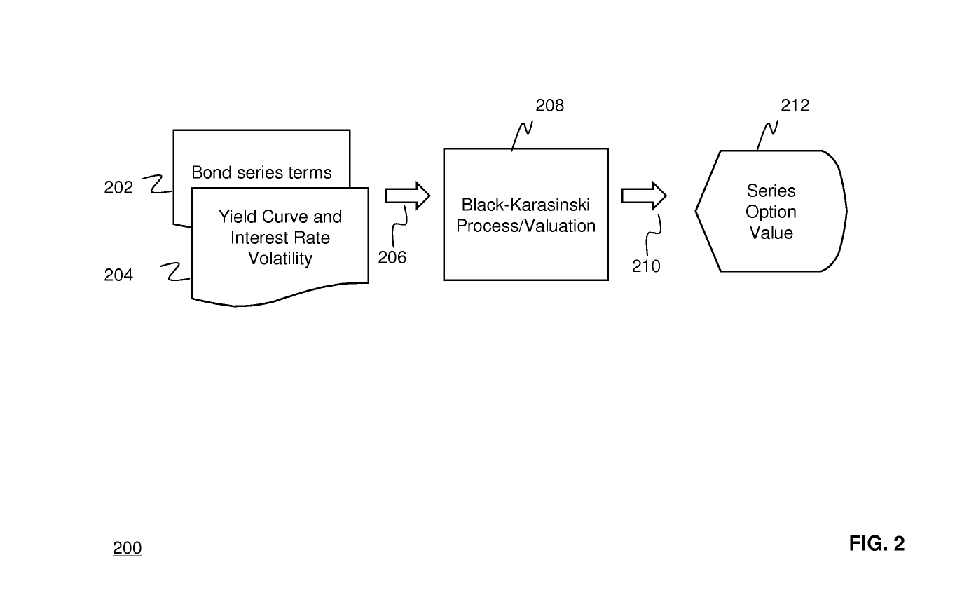

As described below with reference to the flowcharts of FIGS. 2-4, the same process can be applied to determine, from among different series, which is the most preferred.

As outlined in FIGS. 2-4, exemplary methods process the inputs described above and determine which bond series choice is best for an issuer after specifying the evolution of interest rates and taking into account the option-adjusted TIC. For brevity, only the differences occurring within FIGS. 2-4, as compared to previous or subsequent ones of the FIGS. 2-4, are described below.

FIG. 2 is a flowchart illustrating a method 200 of determining a series option value in accordance with an exemplary embodiment.

FIG. 2 is described with continued reference to the embodiments illustrated in FIG. 1. However, FIG. 2 is not limited to that embodiment.

Method 200 begins in when bond series terms 202 and Yield Curve and Interest Rate Volatility data 204 are received. As noted above, bond series terms 202 can quoted to an issuer by various underwriters. The bonds being evaluated by method 200 may have respective option-adjusted spreads determined based on corresponding yield curves relative to a benchmark yield curve and based on an interest rate volatility factor. For example, Yield Curve and Interest Rate Volatility data 204 can include the previous day's industry-standard MMD or MMA curve, or the contemporaneous SIFMA swap curve. An example of yield curve data is provided above in Table 2. In an embodiment, Yield Curve and Interest Rate Volatility data 204 can be provided by communication device 138 depicted in FIG. 1.

In step 206, the received bond series terms 202 and Yield Curve and Interest Rate Volatility data 204 are passed to an interest rate process/bond valuation module 208. In the exemplary embodiment depicted in FIG. 2, interest rate process/bond valuation module 208 uses the Black-Derman-Toy or Black-Karasinski process to specify the evolution of interest rates. As will be appreciated by persons skilled in the relevant art, additional processes besides the Black-Derman-Toy or Black-Karasinski processes can be implemented by interest rate process/bond valuation module 208.

The interest process/bond valuation module 208 produces the bond series option value V in step 210 and stores said series option value V in step 212.

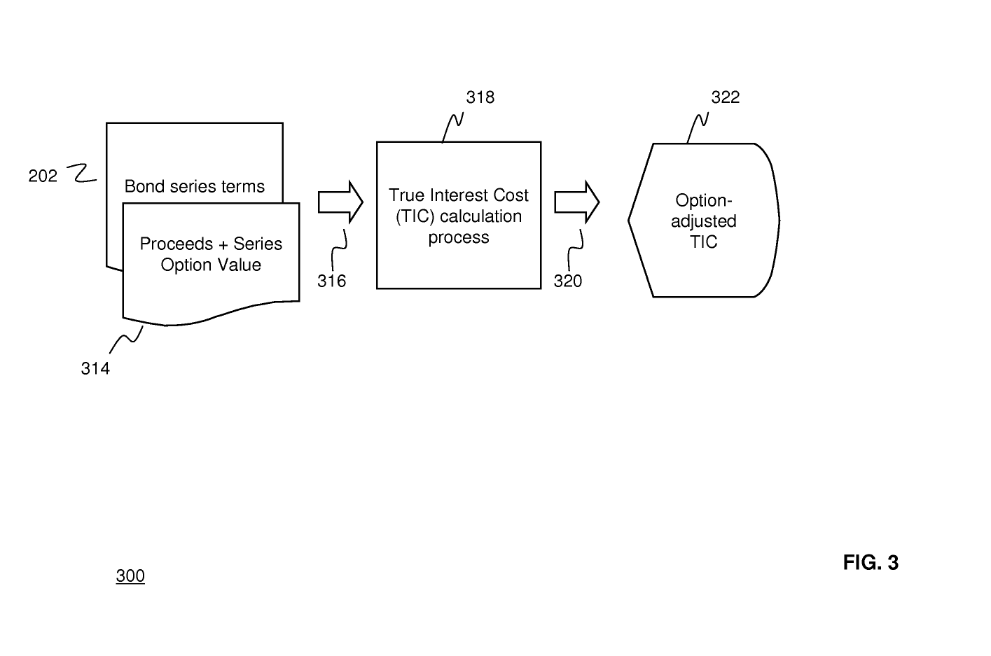

FIG. 3 is a flowchart illustrating a method 300 of determining an option-adjusted TIC in accordance with an exemplary embodiment. FIG. 3 is described with continued reference to the embodiments illustrated in FIGS. 1 and 2. However, FIG. 3 is not limited to those embodiments.

Method 300 begins in when bond series terms 202 and Proceeds and Series Option Value data 314 are received. Proceeds and Series Option Value data 314 comprises the proceeds (represented as a percentage of par value) that a bond issuer will receive. Using the example of Table 1, the 5% bond has proceeds of 105.479% after issuance costs, and it is this 105.479% proceeds value that forms part of Proceeds and Series Option Value data 314. With continued reference to Table 1, Proceeds and Series Option Value data 314 further comprises 5.345% option value of the 5% bond.

In step 316, the received bond series terms 302 and Proceeds and Series Option Value data 314 are passed to a TIC calculation module 318. According to an embodiment, the option-adjusted TIC is obtained in module 318 by adding the option value V to the proceeds P and then finding the single discount rate that equates the present value of the debt service to P+V. The option-adjusted TIC is output in step 320 and stored as data in 322.

The unit of option-adjusted TIC calculated by TIC calculation module 318 is annual interest rate (compounded semiannually).

In the example provided in Table 1, the calculated option-adjusted TIC 320 for the 4.5% and 5% bonds is 4.318% and 4.295%, respectively.

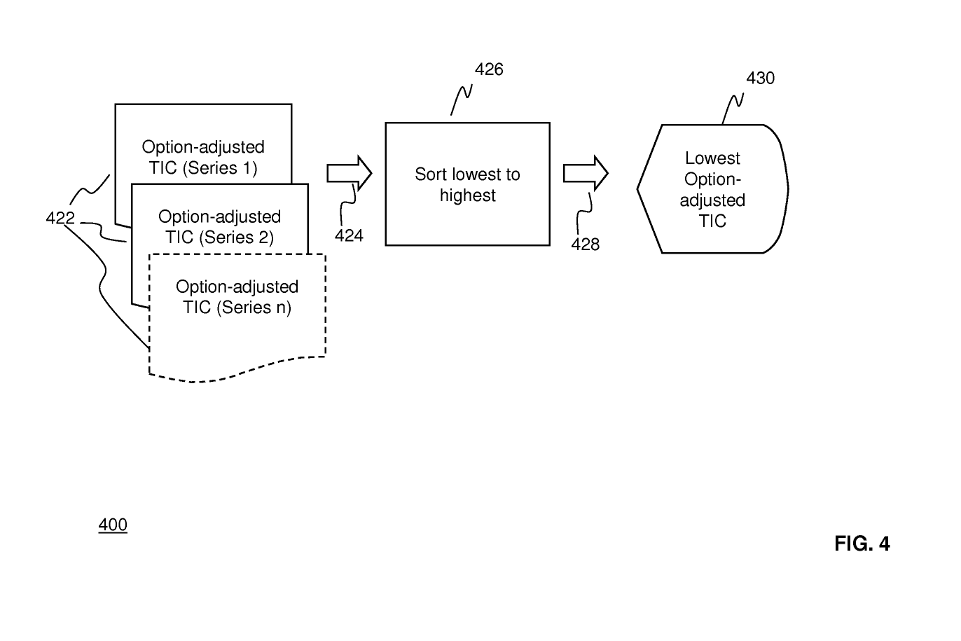

FIG. 4 is a flowchart illustrating a method 400 of determining the lowest option-adjusted TIC for a plurality of series of bonds in accordance with an exemplary embodiment. FIG. 4 is described with continued reference to the embodiments illustrated in FIGS. 1-3. However, FIG. 4 is not limited to those embodiments.

Method 400 begins in when option-adjusted TIC values 422 for a plurality of series are received. In accordance with an embodiment, option-adjusted TIC values 422 can be obtained and provided by TIC module 318 described above with reference to FIG. 3.

In step 424, the received option-adjusted TIC values 422 are passed to a TIC sorting module 426. As shown in FIG. 4, TIC sorting module 426 sorts the option-adjusted TIC values 422 from lowest to highest and passes the sorted option-adjusted TIC values 428 to option-adjusted TIC selector 430.

Option-adjusted TIC selector 430 then selects the lowest option-adjusted TIC value 422 from the sorted option-adjusted TIC values 428. Using the example data provided in Table 1 above, option-adjusted TIC selector would select the bond having a coupon rate of 5% based on its lower option-adjusted TIC of 4.295% over the 4.5% bond having a higher option-adjusted TIC of 4.318%. In this way, method 400 enables selection of the most preferred bond series from amongst a plurality of offerings by not relying solely on the TIC. As noted above with reference to Table 1, traditional techniques relying only on TIC would lead issuers to arrive at the erroneous conclusion that the 4.50% par bonds are preferable to the 5.00% premium bonds based on their lower TIC (4.562% vs. 4.659%.). With continued reference to Table 1, by using TIC module 318 to adjust for option values, method 400 will identify the 5% bonds as being the most preferred based on their lower option-adjusted TIC (4.295% for the 5.00% bonds vs. 4.318% for the 4.50% bonds).

As will be appreciated by persons skilled in the relevant art, one or more exemplary embodiments of the present invention can provide one or more advantages or none at all. For example, improved the bond issuance and redemption of the underlying bond transaction can be facilitated by leveraging conventional TIC and NIC valuation processes with the option-adjusted TIC techniques described herein. Techniques of one or more embodiments of the present system can allow more-accurate valuation of bond offers to be used for a given purchase at a given time, including steps such as determining which of a series of bond offerings is most preferred. The system can employ hardware and/or software aspects. Software includes but is not limited to firmware, resident software, microcode, etc., that has been compiled to program a general-purpose computer to be a specific purpose computer, or run a specific purpose computer. Software might be employed, for example, in connection with one or more computing devices of system 130 all connected with each other through a communications network, such as, but not limited to, the Internet. Different method steps can be performed by different processors. The database memory could be distributed or local and the processors could be distributed or singular. The memory devices could be implemented as an electrical, magnetic or optical memory, or any combination of these or other types of storage devices (including memory portions as described above with respect to cards. It should be noted that if distributed processors are employed, each distributed processor that makes up a processor carrying out a function or step generally contains its own addressable memory space. It should also be noted that some or all of computer systems can be incorporated into an application-specific or general-use integrated circuit. For example, one or more method steps could be implemented in hardware in an ASIC rather than using firmware. Displays used in conjunction with each of the entities and processors are representative of a variety of possible input/output devices.

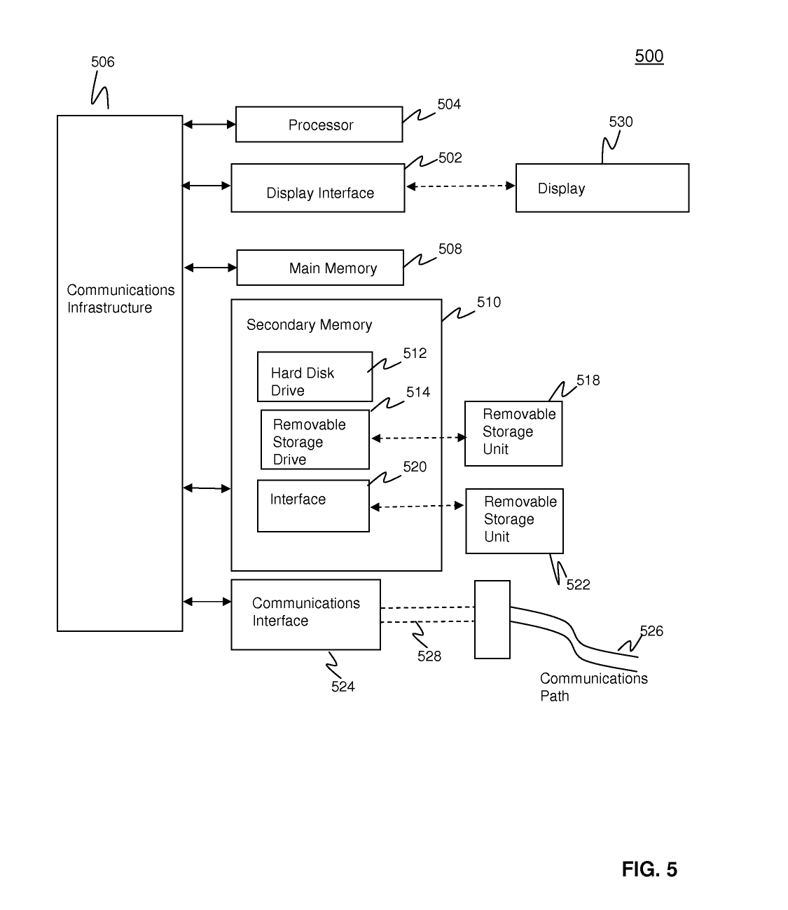

As described below with reference to FIG. 5, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems, computing devices, and servers described herein each contain a memory that will configure associated processors to implement the methods, steps, and functions disclosed herein. Such methods, steps, and functions can be carried out, e.g., by processing capability of one or more computing devices of system 130, which can be in turn connected with each other through a communications network. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

By way of example, a terminal apparatus associated with each of a plurality of computing devices within system 130, all connected with each other through a communications network could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of yet a further example, an active file manager apparatus for processing an active file in a payment system, could include a memory, and at least one processor coupled to the memory. The processor can be operative to perform one or more method steps described herein, or otherwise facilitate their performance.

Although exemplary embodiments have been described in terms of a method or apparatus, it is contemplated that it may be implemented by microprocessors of a computer, such as the computer system 500 illustrated in FIG. 5. In various embodiments, one or more of the functions of the various components may be implemented in software that controls a computing device, such as computer system 500, which is described below with reference to FIG. 5. The processor(s) of the computer system are configured to execute the software recorded on a non-transitory computer-readable recording medium, such as a hard disk drive, ROM, flash memory, optical memory, or any other type of non-volatile memory.

Aspects of the present disclosure shown in FIGS. 1-4, or any part(s) or function(s) thereof, may be implemented using hardware, software modules, firmware, tangible computer readable media having instructions stored thereon, or a combination thereof and may be implemented in one or more computer systems or other processing systems.

FIG. 5 illustrates an example computer system 500 in which embodiments of the present disclosure, or portions thereof, may be implemented as computer-readable code. For example, system 130 of FIG. 1 can be implemented in computer system 500 using hardware, software, firmware, non-transitory computer readable media having instructions stored thereon, or a combination thereof and may be implemented in one or more computer systems or other processing systems. Hardware, software, or any combination of such may embody any of the modules and components used to implement the system and architecture of FIGS. 1 and 2. Similarly, hardware, software, or any combination of such may embody modules and components used to implement the method of FIGS. 2-4.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general-purpose processor device. As will be appreciated by persons skilled in the relevant art, processor device 504 may also be a single processor in a multi-core/multiprocessor system, such system operating alone, or in a cluster of computing devices operating in a cluster or server farm. Processor device 504 is connected to a communication infrastructure 506, for example, a bus, message queue, network, or multi-core message-passing scheme.

Computer system 500 also includes a main memory 508, for example, random access memory (RAM), and may also include a secondary memory 510. Secondary memory 510 may include, for example, a hard disk drive 512, removable storage drive 514. Removable storage drive 514 may comprise a floppy disk drive, a magnetic tape drive, an optical disk drive, a flash memory, or the like.

The removable storage drive 514 reads from and/or writes to a removable storage unit 518 in a well known manner. Removable storage unit 518 may comprise a floppy disk, magnetic tape, optical disk, etc. which is read by and written to by removable storage drive 514. As will be appreciated by persons skilled in the relevant art, removable storage unit 518 includes a non-transitory computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500. Computer system 500 may also include a communications interface 524.

Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in the form of signals, which may be electronic, electromagnetic, optical, or other signals capable of being received by communications interface 524. These signals may be provided to communications interface 524 via a communications path 526. Communications path 526 carries signals and may be implemented using wire or cable, fiber optics, a phone line, a cellular phone link, an RF link or other communications channels.

In this document, the terms “computer program medium,” “non-transitory computer readable medium,” and “computer usable medium” are used to generally refer to media such as removable storage unit 518, removable storage unit 522, and a hard disk installed in hard disk drive 512. Signals carried over communications path 526 can also embody the logic described herein. Computer program medium and computer usable medium can also refer to memories, such as main memory 508 and secondary memory 510, which can be memory semiconductors (e.g. DRAMs, etc.). These computer program products are means for providing software to computer system 500.

Computer programs (also called computer control logic) are stored in main memory 508 and/or secondary memory 510. Computer programs may also be received via communications interface 524. Such computer programs, when executed, enable computer system 500 to implement the present disclosure as discussed herein. In particular, the computer programs, when executed, enable processor device 504 to implement the processes of the present disclosure, such as the steps in the methods illustrated by flowcharts 300, 400 and 500 of FIGS. 2-4, discussed above. Accordingly, such computer programs represent controllers of the computer system 500. Where the present disclosure is implemented using software, the software may be stored in a computer program product and loaded into computer system 500 using removable storage drive 514, interface 520, and hard disk drive 512, or communications interface 524.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way. Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A method of calculating the borrowing cost of municipal debt, comprising:
receiving terms, yield curve and interest rate volatility data for a plurality of municipal debt offerings;
specifying an evolution of interest rates for each of the plurality of municipal debt offerings;
calculating an option value V for each of the plurality of municipal debt offerings;
determining proceeds P for each of the plurality of municipal debt offerings;
determining proceeds P for each of the plurality of municipal debt offerings;
calculating an Option-Adjusted True Interest Cost (OATIC) for each of the plurality of municipal debt offerings by:
adding the respective option values V to the respective proceeds P; and
finding a single discount rate that equates a present value of respective debt service for the plurality of municipal debt offerings to P+V.

2. The method of claim 1, further comprising selecting a municipal debt offering having the lowest OATIC as a most-preferred debt offering.

3. The method of claim 1, wherein terms for the plurality of municipal debt offerings include interest payments to be made periodically, and/or at maturity.

4. The method of claim 1, wherein the plurality of municipal debt offerings comprise a plurality of bond offerings from a respective plurality of bond issuers.

5. The method of claim 4, wherein the plurality of bond offerings comprise municipal bonds whose respective plurality of bond issuers are municipalities, and wherein the terms for the plurality of bond offerings comprise bond terms specified by the municipalities.

6. The method of claim 4, wherein the evolution of interest rates is specified using the Black-Derman-Toy process.

7. The method of claim 4, wherein the evolution of interest rates is specified using the Black-Karasinski process.

8. The method of claim 4, wherein the option value V and the proceeds P are represented as a percentage of par value for the plurality of bond offerings.

9. A system for calculating the borrowing cost of municipal debt, comprising:
means for receiving, from a computing device, terms, yield curve and interest rate volatility data for a plurality of municipal debt offerings;
means for specifying an evolution of interest rates for each of the plurality of municipal debt offerings;
means for receiving, from the computing device, an option value V for each of the plurality of municipal debt offerings;
means for determining proceeds P for each of the plurality of municipal debt offerings;
means for obtaining an Option-Adjusted True Interest Cost (OATIC) for each of the plurality of municipal debt offerings, wherein the means for obtaining comprises:
means for adding the respective option values V to the respective proceeds P; and
means for finding a single discount rate that equates a present value of respective debt service for the plurality of municipal debt offerings to P+V.

10. The system of claim 9, further comprising:
means for selecting a municipal debt offering having the lowest OATIC as a most-preferred debt offering.

11. The system of claim 9, wherein the plurality of municipal debt offerings comprise a plurality of bond offerings from a respective plurality of bond issuers.

12. The system of claim 11, wherein the plurality of bond offerings comprise municipal bonds whose respective plurality of bond issuers are municipalities, and wherein the terms for the plurality of bond offerings comprise bond terms specified by the municipalities.

13. The system of claim 11, wherein the yield curve data for the plurality of municipal debt offerings comprises the previous day's Municipal Market Data (MMD) or Municipal Market Advisors (MMA) curve data.

14. The system of claim 11, wherein the yield curve data for the plurality of municipal debt offerings comprises contemporaneous Securities Industry and Financial Markets Association (SIFMA) Municipal Swap Index data.

15. The system of claim 11, wherein the option value V and the proceeds P are represented as a percentage of par value for the plurality of bond offerings.

16. A non-transitory computer readable storage medium having program instructions stored thereon for selecting a preferred debt instrument for an investor from a plurality of debt instruments, the instructions being executable by a processor of a computing device, the instructions comprising:
instructions for receiving terms, yield curve and interest rate volatility data for a plurality of debt instruments;
instructions for specifying an evolution of interest rates for each of the plurality of debt instruments;
instructions for receiving an option value V for each of the plurality of debt instruments;
instructions for determining proceeds P for each of the plurality of debt instruments;
instructions for obtaining an Option-Adjusted True Interest Cost (OATIC) value for each of the plurality of debt instruments by:
adding the respective option values V to the respective proceeds P; and
finding a single discount rate that equates a present value of respective debt service for the plurality of debt instruments to P+V;
instructions for determining based on the OATIC values, a respective expected cost for each of the plurality of debt instruments;
instructions for selecting a debt instrument for the investor from the plurality of debt instruments based on the respective expected costs of the debt instruments; and
instructions for displaying a report identifying the preferred debt instrument selected for the investor.

17. The non-transitory computer readable storage medium of claim 16, wherein the instructions for displaying comprise:
instructions for sorting the OATIC values from lowest to highest; and
instructions for outputting a sorted list for the plurality of debt instruments.

18. The non-transitory computer readable storage medium of claim 16, wherein the instructions for displaying comprise:
instructions for indentifying, in the report, a municipal debt offering having the lowest OATIC as the preferred debt instrument selected for the investor.

19. The non-transitory computer readable storage medium of claim 16, wherein terms for the plurality of debt instruments include interest payments to be made periodically, and/or at maturity.

20. The non-transitory computer readable storage medium of claim 16, wherein the plurality of debt instruments comprise a plurality of bond offerings from a respective plurality of bond issuers.
